(19) United States
(12) Patent Application Publication
(10) Pub. No.: US 2026/0223224 A1
(43) Pub. Date: Jul. 30, 2026

(54) Wireless Device and Method for Neighbor Awareness Networking with Enhanced Multi-Link Single Radio Operation Support

(71) Applicant: MEDIATEK INC., Hsinchu City (TW)

(72) Inventors: Yi-Jung Ho, Hsinchu City (TW); Pei-Ching Huang, Hsinchu City (TW); Chien-Chih Chen, Hsinchu City (TW); Cheng-Yi Chang, Hsinchu City (TW)

(73) Assignee: MEDIATEK INC., Hsinchu City (TW)

(21) Appl. No.: 19/446,964

(22) Filed: Jan. 13, 2026

Related U.S. Application Data
(60) Provisional application No. 63/749,016, filed on Jan. 24, 2025.

(51) Int. Cl. H04W 76/15; H04B 7/0413; H04W 72/0446

(52) U.S. Cl. CPC H04W 76/15; H04B 7/0413; H04W 72/0446

(57) ABSTRACT

A wireless device and a method enable enhanced multi-link single radio (EMLSR) operation in a Neighbor Awareness Networking (NAN) environment by exchanging capability information and mapping information. The wireless device controls a radio-frequency (RF) transceiver module to alternate between a monitoring configuration during a listen period and an aggregated configuration during an active period. During the listen period, the device monitors a mapped link associated with a NAN map identifier (Map ID) using a 1x1 configuration employing a single RF chain. Upon detecting a trigger frame on the monitored mapped link, the device switches to the aggregated configuration during the active period. In the aggregated configuration, at least two RF chains are aggregated to operate on a target link associated with the trigger frame using a multiple-input multiple-output (MIMO) configuration to perform data communication.

### CROSS REFERENCE TO RELATED APPLICATIONS

This application claims the benefit of U.S. Provisional Application No. 63/749,016, filed on January 24th, 2025. The content of the application is incorporated herein by reference.

### BACKGROUND

Wireless communication technologies have evolved significantly to support the increasing demand for high-speed data transmission and widespread connectivity. The IEEE 802.11 family of standards, commonly known as Wi-Fi^{®}, has introduced various amendments to address these needs. One such development is Neighbor Awareness Networking (NAN), also known as Wi-Fi Aware™, which enables devices to discover each other and establish direct peer-to-peer data paths without the need for a central access point (AP). NAN is typically deployed in complex network environments characterized by multiple devices and overlapping wireless services. Wi-Fi Aware™ is a trademark of Wi-Fi Alliance^{®}.

Concurrently, the IEEE 802.11be amendment, referred to as Extremely High Throughput (EHT), introduces Multi-Link Operation (MLO). MLO allows devices, referred to as Multi-Link Devices (MLDs), to transmit and receive data across multiple frequency bands or channels simultaneously or non-simultaneously. A specific mode within MLO is Enhanced Multi-Link Single Radio (EMLSR). EMLSR is designed to enhance concurrent dual-radio operations, particularly in busy network environments where idle channels may be scarce. In EMLSR, a device with limited radio resources (e.g., a single radio capable of switching frequencies) can monitor multiple links and dynamically switch to the best available link for data transmission. This capability provides low latency and high throughput benefits similar to concurrent dual-radio devices but at a lower hardware cost.

However, a significant problem exists in the integration of these technologies. In current NAN networks, although multiple links can be established and data can be transmitted concurrently on a single radio device, there is no established mechanism to efficiently share a single radio resource and leverage multi-link capabilities for interference mitigation. For example, a dual-map NAN network might only operate in a 1x1 multiple-input multiple-output (MIMO) manner simultaneously for each link in a 2x2 single radio device, failing to fully utilize the radio's potential (e.g., 2x2 MIMO capability). While EMLSR could address this by allowing dynamic switching to utilize full radio capabilities on a single link, there is no specification defining EMLSR behavior for Non-AP stations (STAs) operating specifically as NAN devices. Furthermore, existing NAN specifications utilize NAN map identifiers (Map IDs) to identify availability schedules on specific channels, whereas IEEE 802.11be utilizes Link IDs to identify logical links in a multi-link context. There is currently no mechanism to map these different identifiers to enable EMLSR within a NAN cluster.

### SUMMARY

An embodiment of the present invention provides a wireless device configured to operate as a Neighbor Awareness Networking (NAN) device. The wireless device comprises a processing circuit, a memory, a radio-frequency (RF) transceiver module, and a plurality of antennas. The memory is coupled to the processing circuit. The RF transceiver module is coupled to the processing circuit and includes a plurality of RF chains. The antennas are coupled to the RF transceiver module. The processing circuit is configured to: control the RF transceiver module to operate, in a time-division manner, by alternating between a monitoring configuration during a listen period and an aggregated configuration during an active period; during the listen period, control the RF transceiver module to monitor, using a 1x1 configuration that employs a single RF chain of the plurality of RF chains and a single antenna of the plurality of antennas for each link, a plurality of mapped links respectively associated with different frequency bands and different NAN map identifiers (Map IDs), to detect a trigger frame on any of the monitored mapped links; and in response to detecting the trigger frame, during the active period, control the RF transceiver module to switch to the aggregated configuration in which at least two of the plurality of RF chains are aggregated to operate on a target link associated with the trigger frame using a multiple-input multiple-output (MIMO) configuration that employs at least two antennas of the plurality of antennas, to perform a data communication on the target link.

Another embodiment of the present invention provides a method for operating a wireless device as a Neighbor Awareness Networking (NAN) device. The wireless device comprises a radio-frequency (RF) transceiver module including a plurality of RF chains, and a plurality of antennas coupled to the RF transceiver module. The method comprising: time-division multiplexing operations of the RF transceiver module by alternating between a monitoring configuration during a listen period and an aggregated configuration during an active period; during the listen period, monitoring, using a 1x1 configuration that employs a single RF chain of the plurality of RF chains and a single antenna of the plurality of antennas for each of a plurality of mapped links, the plurality of mapped links respectively associated with different frequency bands and different NAN map identifiers (Map IDs) to detect a trigger frame on any of the monitored mapped links; and in response to detecting the trigger frame, during the active period, switching the RF transceiver module to the aggregated configuration in which at least two RF chains are aggregated to operate on a target link associated with the trigger frame using a multiple-input multiple-output (MIMO) configuration that employs at least two antennas of the plurality of antennas to perform a data communication on the target link.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an example wireless communication system in which wireless devices support Neighbor Awareness Networking (NAN) and Enhanced Multi-Link Single Radio (EMLSR) operation, according to an embodiment of the present disclosure.

FIG. 2 is a diagram illustrating an example data structure for storing mapping information between identifiers used in multi-link operation (MLO) and identifiers used in NAN, according to an embodiment of the present disclosure.

FIG. 3 is a flow diagram illustrating an example procedure for capability negotiation, enablement, and operation of EMLSR within a NAN context, according to an embodiment of the present disclosure.

FIG. 4 is a message sequence diagram illustrating an example procedure associated with NAN service discovery and NAN Data Path setup, including events and frames exchanged between a first NAN device and a second NAN device, according to an embodiment of the present disclosure.

FIG. 5 is a diagram illustrating an example composition of an NAN Data Path (NDP) setup frame carrying EMLSR capability information and mapping information, including an Element Container attribute that encapsulates a multi-link element including an EML capabilities subfield and a NAN Link ID attribute including a list of mapping entries, according to an embodiment of the present disclosure.

FIG. 6 is a timing diagram illustrating an example sequence of trigger and data exchanges associated with EMLSR operation across multiple mapped links, according to an embodiment of the present disclosure.

### DETAILED DESCRIPTION

The present disclosure describes embodiments of a wireless device and method for enabling Enhanced Multi-Link Single Radio (EMLSR) operation in Neighbor Awareness Networking (NAN). The disclosure addresses the inefficiencies of single-radio devices in multi-link peer-to-peer environments by introducing a mechanism to negotiate EMLSR capabilities and map lower-layer Multi-Link Operation (MLO) identifiers to NAN-layer Map identifiers. This integration allows a single-radio device to monitor multiple NAN data paths with reduced resources and dynamically aggregate its radio chains onto a single path for high-speed transmission when activity is detected.

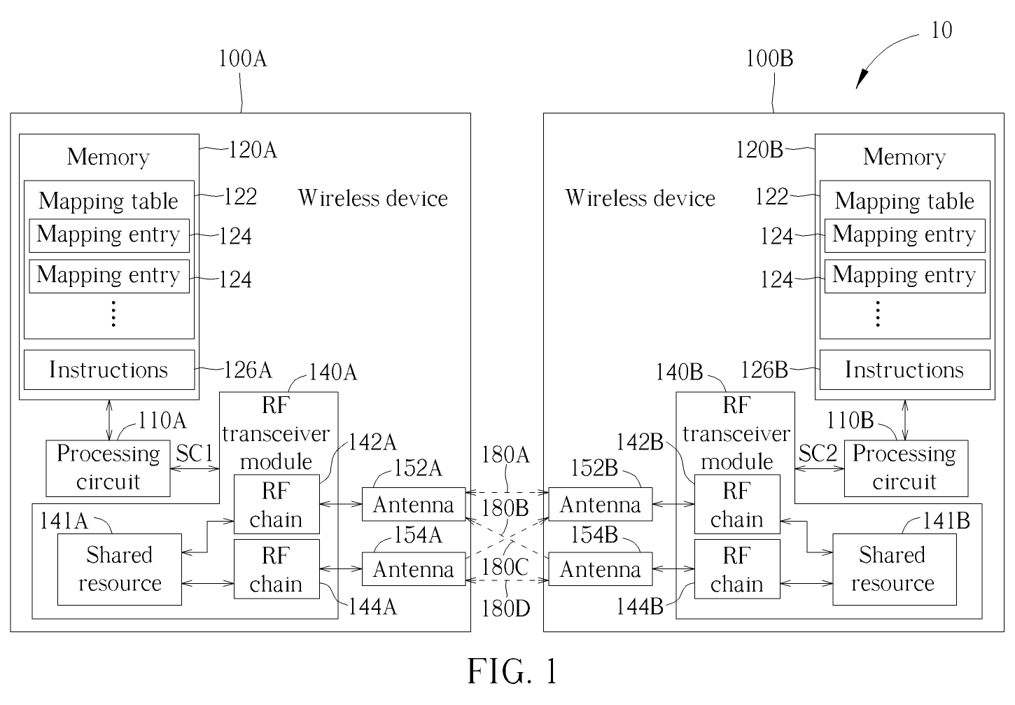

FIG. 1 illustrates a wireless communication system 10 in which aspects of the present disclosure may be implemented. The wireless communication system 10 includes a wireless device 100A and a wireless device 100B. Both the wireless device 100A and the wireless device 100B are configured to support Neighbor Awareness Networking (NAN) and Enhanced Multi-Link Single Radio (EMLSR) operations. The wireless device 100A includes a processing circuit 110A, a memory 120A, and a radio-frequency (RF) transceiver module 140A. Similarly, the wireless device 100B includes a processing circuit 110B, a memory 120B, and an RF transceiver module 140B.

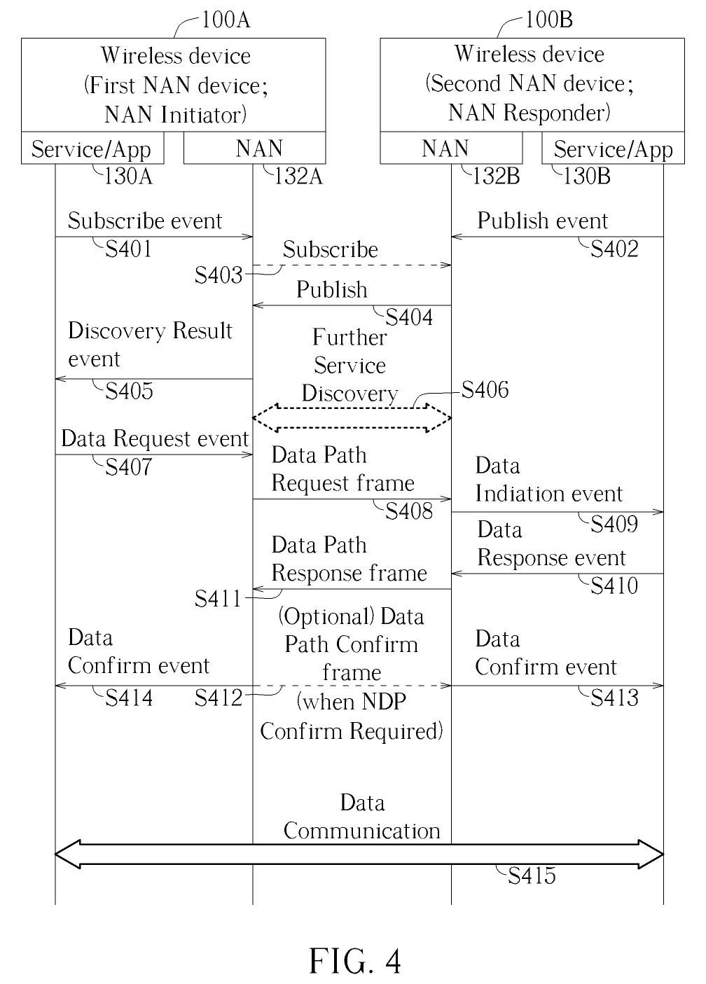

In the embodiment, the wireless device 100A and the wireless device 100B are non-AP stations (non-AP STAs) that participate in a peer-to-peer NAN cluster and establish a NAN Data Path (NDP) without operating as an access point (AP). Stated differently, neither wireless device 100A nor wireless device 100B operates as an infrastructure AP for the communications described herein; instead, each operates in a NAN device role (e.g., NAN Initiator and NAN Responder as described with reference to FIG. 4).

The processing circuit 110A may be implemented as one or more microprocessors, microcontrollers, Application Specific Integrated Circuits (ASICs), Field Programmable Gate Arrays (FPGAs), or digital signal processors (DSPs). It is configured to execute control logic and protocol stacks for IEEE 802.11be and Wi-Fi Aware, including the logic for exchanging frames, detecting trigger frames, controlling radio configurations, and managing the return to monitoring configurations. The memory 120A may include volatile memory (e.g., DRAM, SRAM) and non-volatile memory (e.g., Flash, EEPROM) for storing data and program code.

The RF transceiver module 140A includes a plurality of RF chains, specifically an RF chain 142A and an RF chain 144A. These chains are coupled to the antennas 152A and 154A, respectively. Correspondingly, the RF transceiver module 140B includes an RF chain 142B and an RF chain 144B coupled to the antennas 152B and 154B. Each RF chain typically comprises hardware for signal processing, such as power amplifiers, low-noise amplifiers, mixers, and analog-to-digital/digital-to-analog converters.

In the embodiment of FIG. 1, the RF transceiver module 140A further includes a shared resource 141A that is shared by the RF chain 142A and the RF chain 144A. Similarly, the RF transceiver module 140B further includes a shared resource 141B that is shared by the RF chain 142B and the RF chain 144B. The shared resource 141A/141B may comprise at least one of (i) a shared baseband circuit (e.g., a baseband processor, modem, and/or digital front-end) configured to generate, process, and schedule baseband signals for a plurality of spatial streams, and/or (ii) a shared oscillator (e.g., a reference clock, local oscillator (LO), frequency synthesizer, and/or phase-locked loop (PLL)) configured to provide a common frequency reference and tuning control to the RF chains. In an aggregated configuration using a multiple-input multiple-output (MIMO) configuration on a target link, the shared resource 141A/141B constrains and/or coordinates the RF chains such that the at least two antennas transmit wireless signals on the target link on a same frequency band (e.g., the same channel and band), thereby enabling MIMO transmission on the selected target link. The shared resource 141A/141B is illustrated as a separate functional block for clarity; however, in implementations it may be integrated within the RF transceiver module 140A/140B, within a shared RFIC/baseband chipset, or otherwise implemented as circuitry shared by the plurality of RF chains.

In the context of the present disclosure, a "Single Radio" device, such as the wireless device 100A or the wireless device 100B, is defined as a device that may have multiple radio-frequency (RF) chains, for example enabling 2x2 multi-input multi-output (MIMO) capability, and that shares, via the shared resource 141A or 141B, a common baseband and/or local oscillator resource, such that full MIMO capability is ordinarily applied on one selected frequency band at a time rather than being independently applied on two widely separated frequency bands simultaneously for transmission or reception. However, using enhanced multi-link single radio (EMLSR), such a single radio device can dynamically switch its full radio resources to a single link to maximize throughput when active, while splitting resources to monitor multiple links when idle. The processing circuit 110A generates a switching control signal SC1 to dynamically configure the RF transceiver module 140A, and the processing circuit 110B generates a switching control signal SC2 for the RF transceiver module 140B. This control allows the wireless devices 100A and 100B to switch between a monitoring configuration, in which multiple links are monitored, and an aggregated configuration, in which communication is performed on a selected link. The communication takes place over wireless links illustrated as radio signals 180A, 180B, 180C, and 180D, which can represent different spatial streams or radio signals on different frequency bands depending on the configuration.

The memory 120A stores a mapping table 122 containing mapping entries 124 and instructions 126A. Similarly, the memory 120B stores the mapping table 122 and instructions 126B. These mapping entries 124 are used for enabling EMLSR in a NAN environment because they bridge the gap between the IEEE 802.11be standard, which uses "Link IDs" to identify links in a multi-link context, and the Wi-Fi Aware standard, which uses "Map IDs" (often associated with a NAN Availability Attribute) to identify logical channels or "maps" in a NAN cluster. The mapping entries 124 provide a clear translation between identifiers used at different layers and in different specifications. The IEEE 802.11be standard uses a Link ID to label a link for multi-link operation. The Wi-Fi Aware standard uses a NAN map identifier (Map ID) to label a NAN map that represents an availability schedule. The mapping table 122 ties a Link ID to a corresponding Map ID. With this one to one correspondence, the wireless device 100A can interpret a NAN map as a specific EMLSR-capable link. The wireless device 100B can do the same using the same mapping information. This allows the processing circuit 110A and the processing circuit 110B to select the correct link when they monitor multiple links or aggregate RF chains on a target link. It also allows the devices to apply the EMLSR capability information to the intended NAN map during operation.

The instructions 126Acomprise computer-executable code that, when executed by the processing circuit 110A, causes the wireless device 100A to perform the methods described herein. Similarly, the instructions 126B comprise computer-executable code that, when executed by the processing circuit 110B, causes the wireless device 100B to perform the methods described herein.

In some embodiments, the wireless device 100A and the wireless device 100B are not limited to the two antenna example shown in FIG. 1. The depiction of two antennas (e.g., antennas 152A and 154A, and antennas 152B and 154B) and two RF chains (e.g., RF chains 142A and 144A, and RF chains 142B and 144B) corresponds to an illustrative 2x2 MIMO example and is not limiting. For example, the wireless device 100A may include three or more antennas and the wireless device 100B may include three or more antennas, and the RF transceiver module 140A and the RF transceiver module 140B may each include three or more RF chains coupled to the respective antennas. In such implementations, the plurality of antennas and the plurality of RF chains may support an NxN (or more generally NxM) MIMO configuration using at least two, and in some cases three or more, spatial streams on the target link during the aggregated configuration. In addition, the communication between the wireless device 100A and the wireless device 100B is not limited to two links. For example, the wireless device 100A and the wireless device 100B may establish and operate over a plurality of links, in which each link is identified by a respective Link ID for multi-link operation and is associated with a respective Map ID for NAN scheduling. In such embodiments, the mapping table 122 may store a plurality of mapping entries 124 that provide one to one correspondences between a plurality of Link IDs and a plurality of Map IDs, and the processing circuit 110A and the processing circuit 110B may select a target link from among the plurality of links for an aggregated configuration while monitoring a subset of the plurality of links in a monitoring configuration.

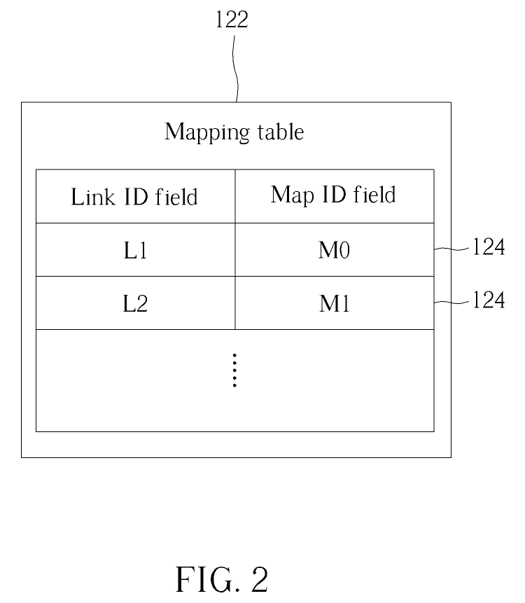

Referring now to FIG. 2, a diagram illustrating an example structure of a mapping table 122 is shown. The mapping table 122 includes one or more mapping entries 124, and each mapping entry 124 provides a one to one correspondence between a multi-link operation identifier and a NAN identifier. In some implementations, the mapping table 122 is stored in the memory 120A and the memory 120B and is accessed by the processing circuit 110A and the processing circuit 110B.

As shown in FIG. 2, the mapping table 122 includes a Link ID field and a Map ID field. The Link ID field specifies a link identifier (e.g., a 4-bit value ranging from 0 to 15) assigned to a logical link in accordance with the IEEE 802.11be standard. The Map ID field specifies a corresponding NAN map identifier (e.g., a 4-bit value) associated with a NAN Availability Attribute or Further Availability Map Attribute in accordance with the Wi-Fi Aware standard. Each mapping entry 124 establishes a binding between a specific Link ID and a specific Map ID. By consulting the mapping table 122, the processing circuit 110A can determine that a NAN data path scheduled on “Map ID” corresponds to “Link ID” for the purpose of EMLSR state transitions. This enables the processing circuit 110A to apply EMLSR logic (e.g., antenna switching triggers) defined for Link IDs to the corresponding NAN Maps. In an example mapping entry 124, the Link ID field includes L1 and the Map ID field includes M0. In another example mapping entry 124, the Link ID field includes L2 and the Map ID field includes M1. The ellipsis indicates that additional mapping entries 124 may be included in the mapping table 122.

By maintaining the mapping table 122, the processing circuit 110A can select a target link for an EMLSR operation and apply the corresponding Map ID for NAN control and scheduling. Similarly, the processing circuit 110B can use the same mapping information to align link selection with Map ID usage during monitoring and during an aggregated configuration. This mapping helps the wireless device 100A and the wireless device 100B use the same identifiers for the same physical link across different protocol functions. The processing circuit 110A and the processing circuit 110B may use a Link ID when controlling the RF transceiver module, and may use a Map ID when performing a NAN procedure that refers to a NAN map. By using the mapping entries 124 in the mapping table 122, the devices can treat a given Link ID and a given Map ID as referring to the same link.

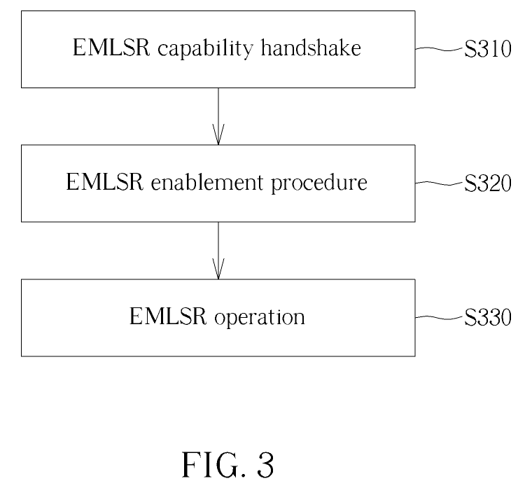

FIG. 3 illustrates a high level procedure for operating EMLSR. The procedure includes an EMLSR capability handshake S310, an EMLSR enablement procedure S320, and an EMLSR operation S330.

During the EMLSR capability handshake S310, a wireless device 100A and a wireless device 100B exchange capability information to determine whether EMLSR is supported. In some embodiments, this handshake exchange is performed during establishment of a connection in a NAN environment, for example during a NAN Data Path (NDP) setup. One or more NDP setup frames may convey the EMLSR capability information and may also convey mapping information that associates a Link ID with a Map ID. The EML Capabilities are defined in the IEEE 802.11be standard and include subfields such as "EMLSR Support" (a bit indicating if the device can perform EMLSR) and delay parameters like "EMLSR Padding Delay" and "EMLSR Transition Delay." In one embodiment, the EML Capabilities are carried as an EML Capabilities subfield within a Multi-Link element, and the EML Capabilities subfield includes an EMLSR Support bit, an EMLMR Support bit, an EMLSR Padding Delay field, and an EMLSR Transition Delay field as described in an IEEE 802.11be draft, such as D7.0, or in an equivalent description thereof. These delay parameters specify the time required for the device to switch its radio configuration. In this embodiment, these standard capabilities are encapsulated within NAN frames. In one embodiment, the EMLSR capability information further includes an Extended MLD Capabilities and Operations field that indicates whether EMLSR is supported on at least one link and may include an EMLSR Transition Timeout field.

After the devices have determined that EMLSR is supported, the procedure proceeds to the EMLSR enablement procedure S320. In this stage, the wireless device 100A and the wireless device 100B exchange control information using an EML Operating Mode Notification frame (or a functionally equivalent control frame conveying an EML Control field) as defined or evolved in IEEE 802.11be. In one embodiment, the EML Operating Mode Notification frame includes an EML Control field that includes (i) an EMLSR Mode subfield (which may also be referred to as an EML Mode subfield in certain implementations and/or standard revisions) that indicates enablement or disablement of an enhanced multi-link mode for the recipient, and (ii) a bitmap subfield that identifies one or more Link IDs to which the indicated mode applies. In some implementations and/or standard revisions, the bitmap subfield that identifies the one or more Link IDs for EMLSR operation may be referred to as an “EMLSR Link Bitmap” or more generally as an “EML Link Bitmap.” As used herein, unless the context clearly indicates otherwise, the term “EML Link Bitmap” encompasses an “EMLSR Link Bitmap” when the indicated mode corresponds to EMLSR operation, and the term “EMLSR Link Bitmap” refers to the foregoing bitmap subfield used for identifying the one or more Link IDs for EMLSR operation. The processing circuit 110A or 110B applies the mapping entries 124 of the mapping table 122 to translate the Link IDs indicated by the bitmap subfield into Map IDs used by NAN scheduling. For example, if bit 1 and bit 2 are set in the bitmap subfield, it implies that the links corresponding to Link ID 1 and Link ID 2 are enabled for EMLSR operation.

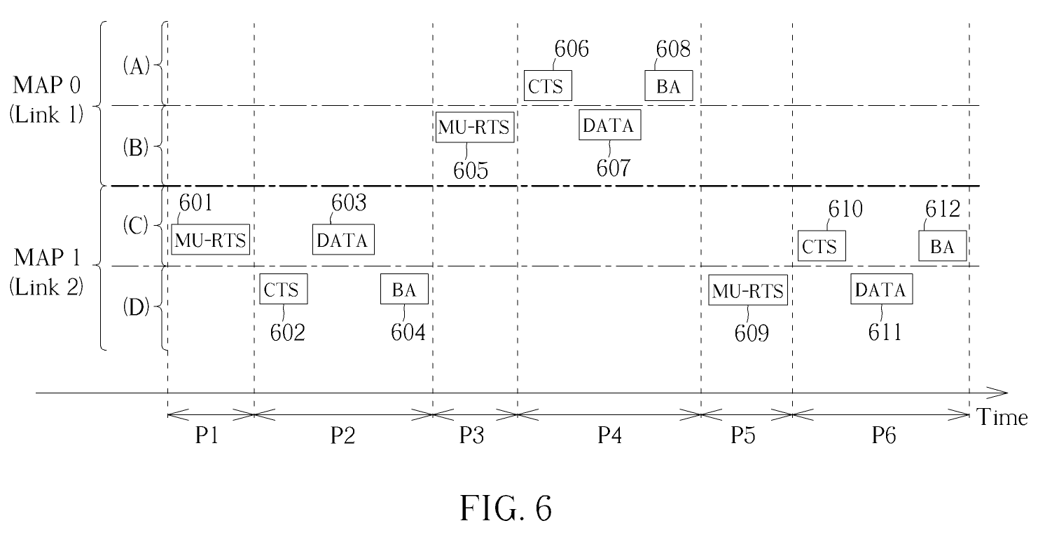

After EMLSR is enabled, the wireless device 100A and the wireless device 100B enter the EMLSR operation S330. In this stage, the devices perform dynamic control of radio resources with respect to multiple links, including monitoring more than one link and aggregating radio resources on a selected link when a transmission opportunity (TXOP) is detected. In some embodiments, the EMLSR operation S330 includes switching between a monitoring configuration that uses 1x1 operation on multiple links and an aggregated configuration that uses 2x2 operation on a target link for a data frame exchange sequence, as described in further detail with reference to FIG. 6.

FIG. 4 provides an example message sequence in a Neighbor Awareness Networking (NAN) service discovery and data path setup context, according to an embodiment of the present disclosure. The figure is adapted to align with the general signaling flow shown in FIG. 30 of the Wi-Fi Aware Specification v4.0, while illustrating how the disclosed techniques may be applied during the setup and subsequent communication. In FIG. 4, the wireless device 100A is also labeled as a first NAN device or a NAN Initiator, and the wireless device 100B is also labeled as a second NAN device or a NAN Responder.

The message sequence involves a Service/App layer 130A and a NAN layer 132A at the wireless device 100A and a Service/App layer 130B and a NAN layer 132B at the wireless device 100B. The process may begin with a subscribe event S401 at the wireless device 100A and a publish event S402 at the wireless device 100B. In response, the NAN layer 132A and the NAN layer 132B perform a subscribe procedure S403 and a publish procedure S404, which represent NAN level signaling that supports service discovery, according to an embodiment of the present disclosure. When a match is identified, a discovery result event S405 is generated. Further service discovery S406 may be performed to exchange additional service discovery information, according to an embodiment of the present disclosure.

After service discovery, a data request event S407 may trigger a data path setup. Step S408 corresponds to a transmission of a Data Path Request frame from the wireless device 100A toward the wireless device 100B. At the wireless device 100B, the receipt of the Data Path Request frame is associated with a data indication event S409, and a data response event S410 may be generated to proceed with the setup. Step S411 corresponds to a transmission of a Data Path Response frame from the wireless device 100B toward the wireless device 100A. Step S412 corresponds to an optional transmission of a Data Path Confirm frame when an NDP confirm is required, according to an embodiment of the present disclosure. The Data Path Request frame of S408, the Data Path Response frame of S411, and the optional Data Path Confirm frame of S412 may be collectively referred to as one or more NDP setup frames, according to an embodiment of the present disclosure. In one embodiment, each of the Data Path Request frame, the Data Path Response frame, and the Data Path Confirm frame is a NAN Action Frame that includes an Organization Identifier field identifying NAN. For example, the Organization Identifier field may include an OUI type field (e.g., having a value of 0x18). In an example implementation, the Data Path Request frame may have an OUI subtype field (e.g., 0x05), the Data Path Response frame may have an OUI subtype field (e.g., 0x06), and the Data Path Confirm frame may have an OUI subtype field (e.g., 0x07). The particular OUI type and/or OUI subtype values described herein are provided as non-limiting examples, and other values may be used depending on implementation details and/or specification revisions.

In accordance with an embodiment of the present disclosure, the one or more NDP setup frames convey Enhanced Multi-Link Single Radio (EMLSR) capability information and mapping information that provides a one-to-one correspondence by associating at least two multi-link operation (MLO) link identifiers (Link IDs) with respective different NAN map identifiers (Map IDs). In one embodiment, the EMLSR capability information is carried in an Element Container attribute within an Information Content field of the NAN Action Frame, and the mapping information is carried in a NAN Link ID attribute within the Information Content field of the NAN Action Frame. The mapping information may be used to form the mapping entries 124 that are stored in the memories 120A and 120B, and the stored mapping entries 124 may be used to support subsequent monitoring and switching behaviors described elsewhere in the specification, according to an embodiment of the present disclosure. After the data confirm event S413 and the data confirm event S414, data communication S415 may proceed between the wireless device 100A and the wireless device 100B using the established setup, according to an embodiment of the present disclosure.

In one preferred embodiment, the mapping information is carried via a “NAN Link ID Attribute.” In a first implementation approach, to ensure compatibility with existing Wi-Fi Aware specifications and allow for proprietary or pre-standard extensions, the NAN Link ID attribute may be formatted as a Vendor Specific Attribute (Attribute ID 0xDD). As generally defined in Wi-Fi Alliance specifications, a Vendor Specific Attribute comprises an Attribute ID (0xDD), a Length field, an Organizationally Unique Identifier (OUI), and a Vendor Specific Body. In this embodiment, the Vendor Specific Body is structured to contain the mapping entries 124. For example, the body may include a “Number of Entries” field followed by a sequence of pairs, where each pair consists of a “Link ID” (mapping to the 802.11be Multi-Link Element) and a “Map ID” (mapping to the NAN Availability Attribute). This structure allows legacy NAN devices to ignore the attribute while enabled devices can decode the critical mapping information. In a second implementation approach, the NAN Link ID attribute may be implemented as a non-vendor-specific NAN attribute identified by a dedicated Attribute ID value (e.g., an implementation-specific value such as 0x2F, or a value that may be assigned in a future specification revision).

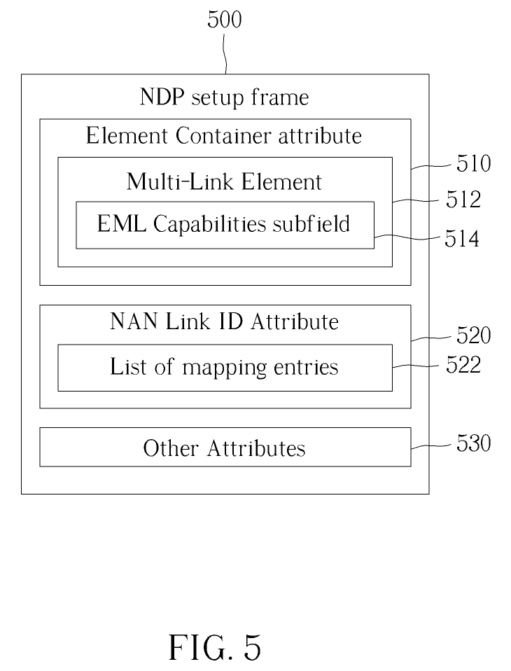

FIG. 5 illustrates the composition of an example NDP setup frame 500 used to convey the information described herein. The frame includes a collection of attributes formatted according to the Wi-Fi Aware specification. To support IEEE 802.11be features within the Wi-Fi Aware protocol without redefining every field, an Element Container attribute 510 is utilized.

The Element Container attribute 510 is a NAN attribute designed to encapsulate information elements (IEs) defined in the IEEE 802.11 standard. In some implementations, the Element Container attribute 510 may be identified by an Attribute ID (e.g., 0x1D in an example Wi-Fi Aware specification). In the NAN context, information that may be informally referred to as an information element (IE) in some discussions may be implemented as a NAN attribute (including a vendor-specific NAN attribute) carried in the Information Content field of a NAN Action Frame. In one embodiment, the Element Container attribute 510 includes an attribute ID field, a length field, a map ID field, and an elements field. The map ID field indicates whether the encapsulated elements apply to a specified NAN availability map and includes a map identifier value, and the elements field includes one or more encapsulated information elements. In this disclosure, the Element Container attribute 510 encapsulates a multi-link element 512 (an 802.11be IE). In one example implementation, the multi-link element 512 may be an Extension element (e.g., having an element ID value 255 and an element ID extension value 107). The multi-link element 512 includes an EML capabilities subfield 514. The EML capabilities subfield 514 contains the specific bits defined in 802.11be, such as the "EMLSR Support" bit (indicating the device's hardware capability for single-radio multi-link operation) and the "EMLSR Transition Delay" (indicating the time required to switch radio configurations). By using the Element Container attribute 510, the disclosure transports these standard IEEE definitions across the NAN protocol.

Simultaneously, the NDP setup frame 500 includes a NAN Link ID attribute 520. In one embodiment, the NAN Link ID attribute 520 is carried as a NAN attribute in the Information Content of the NAN Action Frame. The NAN Link ID attribute 520 may be identified by a Vendor Specific Attribute ID (e.g., 0xDD). Alternatively, the NAN Link ID attribute 520 may be implemented as a non-vendor-specific NAN attribute identified by a dedicated Attribute ID value (e.g., an implementation-specific value such as 0x2F in an example implementation, or a value that may be assigned in a future specification revision). This disclosure defines the NAN Link ID attribute 520 to carry the mapping information. It includes a list of mapping entries 522. In one embodiment, the NAN Link ID attribute includes a Length field and a Link ID Entry list. Each Link ID Entry includes a Link ID field representing a MLO link identifier and a Map ID field representing a NAN map identifier, thereby providing the one-to-one correspondence stored as the mapping entries 124 of the mapping table 122. Each entry in this list contains the Link ID (the 802.11be identifier) and the corresponding Map ID (the NAN identifier), creating the association described in FIG. 2. The NDP setup frame 500 may also include other attributes 530 required for NAN operation, such as NAN availability attributes (defining the time/channel of the Maps), device capability attributes, or NDP-specific attributes. The particular Attribute ID values and element identifier values described herein are provided as non-limiting examples, and other values may be used depending on implementation details and/or specification revisions.

By combining the Element Container attribute 510 (for standard capabilities) and the NAN Link ID attribute 520 (for the specific mapping), the NDP setup frame 500 fully enables EMLSR in the NAN context. This capability exchange constitutes the "EMLSR capability handshake" (step S310) described in FIG. 3.

FIG. 6 illustrates an example timing behavior of Enhanced Multi-Link Single Radio (EMLSR) operation between the wireless device 100A and the wireless device 100B under a Neighbor Awareness Networking (NAN) peer-to-peer context. FIG. 6 is organized into four regions, in which region (A) and region (C) indicate actions of the wireless device 100A on different NAN map identifiers (Map IDs), and region (B) and region (D) indicate actions of the wireless device 100B on different Map IDs. The mapped links are shown as MAP 0 (Link 1) and MAP 1 (Link 2), which are examples of mapped links and are not limited to any specific channel numbers.

Before the timing behavior in FIG. 6 begins (i.e., prior to period P1), the wireless devices 100A and 100B have already completed an EMLSR capability handshake (step S310) and, in some embodiments, an EMLSR enablement procedure (step S320), for example during establishment of a NAN Data Path (NDP). During that setup phase, one or more NDP setup frames are exchanged to establish the NDP and to convey EMLSR capability information (e.g., a Multi-Link element and an EML Capabilities subfield) and to create and store a one-to-one correspondence as mapping entries by associating at least two MLO link identifiers (Link IDs) with respective different Map IDs. Accordingly, the timing behavior of FIG. 6 corresponds to an EMLSR operation phase (step S330) that begins after the setup has completed, and the devices maintain the mapping entries and the negotiated EMLSR capability information while alternating between listen periods and active periods.

Time in FIG. 6 progresses from left to right through periods P1, P2, P3, P4, P5, and P6. Period P1, period P3, and period P5 are listen periods in which the devices operate in a monitoring configuration. Period P2, period P4, and period P6 are active periods in which the devices operate in an aggregated configuration to complete a data frame exchange sequence on a target link. Stated directly, the correspondence is listen in period P1, active in period P2, listen in period P3, active in period P4, listen in period P5, and active in period P6.

In some embodiments, NAN availability is scheduled using a Discovery Window (DW) and a Further Availability Window (FAW), and an availability attribute may be associated with a corresponding Map ID. By way of example, a first availability attribute (e.g., a FAW) may be associated with Map ID 0 and may indicate operation on a 2.4 GHz band channel 6, and a second availability attribute (e.g., a FAW) may be associated with Map ID 1 and may indicate operation on a 5 GHz band channel 149. The mapping table 122 may store mapping entries that associate Link ID 1 with Map ID 0 and associate Link ID 2 with Map ID 1.

During listen periods (e.g., periods P1, P3, and P5), the NAN device may operate in the monitoring configuration in which a first RF chain monitors the mapped link corresponding to Map ID 0 (e.g., CH6, 1x1) and a second RF chain monitors the mapped link corresponding to Map ID 1 (e.g., CH149, 1x1), such that the NAN device can detect a trigger frame on either mapped link. During active periods (e.g., periods P2, P4, and P6), responsive to a trigger frame detected on one of the mapped links, the NAN device may transition to the aggregated configuration in which the RF chains are combined on a selected target link (e.g., CH6, 2x2 during one active period, or CH149, 2x2 during another active period). During the listen periods period P1, period P3, and period P5, the wireless device 100A and the wireless device 100B maintain awareness of activity on multiple mapped links at the same time. In an embodiment, the monitoring configuration uses a reduced capability per mapped link, such as a 1x1 configuration on each mapped link being monitored. A 1x1 configuration refers to using one radio-frequency chain and one spatial stream on a mapped link. This 1x1 monitoring behavior allows the devices to listen on the MAP 0 (Link 1) and the MAP 1 (Link 2).

A transition from the monitoring configuration to the aggregated configuration is triggered by a trigger frame that is transmitted or received on a mapped link. In the illustrated embodiment of FIG. 6, the trigger frame is a Multi-User Request-to-Send (MU-RTS) frame 601, a MU-RTS frame 605, or a MU-RTS frame 609. In other embodiments, the trigger frame comprises a trigger-type control frame selected from the group consisting of a Request-to-Send (RTS) frame, a MU-RTS frame, a Buffer Status Report Poll (BSRP) frame, and a trigger frame that schedules an uplink multi-user transmission.

An RTS frame is a control frame used to reserve the medium and solicit a Clear-to-Send (CTS) response prior to data transmission. A MU-RTS frame is a control trigger frame used to solicit CTS responses and to reserve a protected transmission opportunity (TXOP) for a subsequent multi-user frame exchange on the link that carries the MU-RTS frame. A Buffer Status Report Poll (BSRP) frame is a trigger-type control frame used to solicit a buffer status report so that a peer device can indicate an amount of buffered uplink data (or other uplink status) prior to an uplink multi-user transmission. A trigger frame that schedules an uplink multi-user transmission is a trigger-type control frame that conveys uplink scheduling information (e.g., resource allocation and transmission parameters) for an uplink multi-user transmission such as uplink Orthogonal Frequency Division Multiple Access (OFDMA) and/or uplink Multi-user MIMO (MU-MIMO).

In this embodiment, when the trigger frame is detected during a listen period, the mapped link on which that trigger frame is transmitted or received is selected as the target link for the next active period. The selection is supported by the stored mapping entries, which allow the processing circuit to consistently identify the Map ID and the corresponding link context associated with the detected activity.

During an active period, the wireless device 100A and the wireless device 100B switch to the aggregated configuration so that multiple radio-frequency chains are aggregated to operate on the target link with increased capability. In one embodiment, during the aggregated configuration the RF transceiver module uses the shared resource (e.g., the shared baseband circuit and/or the shared oscillator described with reference to FIG. 1) to drive at least two aggregated RF chains coherently on the target link on the same frequency band. During each active period (e.g., periods P2, P4, and P6), responsive to detection of the trigger frame on a particular mapped link, each device transitions to the aggregated configuration by aggregating at least two RF chains on the selected target link. In the aggregated configuration, the shared resource 141A/141B coordinates the aggregated RF chains to operate on the same frequency band of the target link and to drive at least two antennas for MIMO operation, such that the data communication on the target link is performed using at least two spatial streams. In an embodiment, the aggregated configuration uses a 2x2 configuration on the target link. A 2x2 configuration refers to using two radio-frequency chains and two spatial streams on the target link, which supports higher throughput and improved link robustness relative to 1x1 operation. The switching can be coordinated by switching control signaling between a processing circuit and a RF transceiver module so that the RF chains are aggregated on the target link for the duration of the active period and are released when the data exchange sequence completes.

With reference to FIG. 1 and FIG. 6, the alternating listen periods and active periods correspond to dynamic reconfiguration of the RF transceiver modules 140A and 140B by the processing circuits 110A and 110B using switching control signaling (e.g., SC1 and SC2). During each listen period (e.g., periods P1, P3, and P5), each device operates in the monitoring configuration by allocating a respective RF chain to each mapped link being monitored, such that each mapped link is monitored using a 1x1 configuration (one RF chain and one antenna per mapped link). For example, the processing circuit 110A can control the RF transceiver module 140A to couple the RF chain 142A to the antenna 152A for monitoring MAP 0 (Link 1) while coupling the RF chain 144A to the antenna 154A for monitoring MAP 1 (Link 2), or vice versa, and the processing circuit 110B can perform a corresponding allocation in the RF transceiver module 140B. In this monitoring configuration, the RF chains remain part of a single radio device because they share a common radio resource (e.g., the shared resource 141A/141B comprising a shared baseband circuit and/or a shared oscillator) rather than being independent radios.

In the illustrated timing example, the per-period operation can be understood as follows. With further reference to FIG. 1, during each listen period the processing circuit 110A configures the RF transceiver module 140A in a monitoring configuration in which each mapped link is monitored using a 1x1 configuration, for example by operating one RF chain (e.g., RF chain 142A or RF chain 144A) coupled to one antenna (e.g., antenna 152A or antenna 154A) for that mapped link, while the RF chains share the shared resource 141A. During each active period, the processing circuit 110A switches at least two RF chains and at least two antennas to the selected target link and operates them under control of the shared resource 141A to transmit and/or receive one or more data frames using a MIMO configuration.

FIG. 6 shows a data frame exchange sequence in each active period, and it uses numbered frames to indicate the order and the mapped link context. After the MU-RTS frame 601, the active period P2 includes the Clear-to-Send (CTS) frame 602, the data frame 603, and the Block Acknowledgment (BA) frame 604 on the target link. A Clear-to-Send (CTS) frame is a control frame that grants permission to proceed and reserves the medium for the follow on transmission interval on the target link, thereby reducing the likelihood of interference from other transmissions. A data frame carries payload information during the aggregated 2x2 operation on the target link. A Block Acknowledgment (BA) frame is an acknowledgment control frame that confirms reception status for the data transfer, allowing the devices to close the exchange cleanly and to return to the monitoring configuration. The same functional roles apply in the later active periods, in which the MU-RTS frame 605 is followed by the CTS frame 606, the data frame 607, and the BA frame 608 during period P4, and the MU-RTS frame 609 is followed by the CTS frame 610, the data frame 611, and the BA frame 612 during period P6. The repeated pattern across the period P2, the period P4, and the period P6 reflects that the devices can repeatedly and dynamically allocate full capability to a target link whenever a trigger frame indicates an imminent exchange opportunity on that link.

The listen to active alternation in period P1 through period P6 also clarifies how EMLSR improves efficiency relative to earlier single radio behaviors. In some earlier approaches, a device monitors different links in separate time portions, which can delay detection of a transmission opportunity (TXOP) on a link that is not being monitored at that moment. In other earlier approaches, a device remains in a reduced capability configuration even during a payload transfer, which can increase the time needed to deliver the same amount of data and can reduce overall system efficiency in a busy environment. In the embodiment of FIG. 6, the devices maintain simultaneous awareness of multiple mapped links during the listen periods using 1x1 monitoring, and then promptly concentrate resources into a 2x2 aggregated configuration during the active periods to complete the exchange on the target link. This shortens the active occupancy time for a given payload transfer, improves throughput on demand.

In summary, the present disclosure provides a wireless device and a corresponding method for enabling Enhanced Multi-Link Single Radio (EMLSR) operations within a Neighbor Awareness Networking (NAN) environment. Addressing the prior art limitation where no mechanism exists to efficiently share single radio resources or map IEEE 802.11be Link identifiers to NAN Map identifiers, the disclosed solution utilizes NAN Data Path (NDP) setup frames to convey EMLSR capability and mapping information that establishes a one-to-one correspondence between Multi-Link Operation (MLO) Link IDs and NAN Map IDs. This mapping enables a single-radio device to split its radio frequency chains to monitor multiple mapped links in a monitoring configuration. Upon detecting a trigger frame on a specific link, the device dynamically switches to an aggregated configuration, combining radio resources to utilize full MIMO capabilities on the target link for data exchange. This approach overcomes the inefficiencies of static single-radio operations by allowing dynamic resource aggregation, thereby providing low latency and high throughput benefits similar to concurrent dual-radio devices but at a lower hardware cost.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A wireless device configured to operate as a Neighbor Awareness Networking (NAN) device, comprising:
a processing circuit;
a memory coupled to the processing circuit;
a radio-frequency (RF) transceiver module coupled to the processing circuit, the RF transceiver module including a plurality of RF chains; and
a plurality of antennas coupled to the RF transceiver module;
wherein the processing circuit is configured to:
control the RF transceiver module to operate, in a time-division manner, by alternating between a monitoring configuration during a listen period and an aggregated configuration during an active period;
during the listen period, control the RF transceiver module to monitor, using a 1x1 configuration that employs a single RF chain of the plurality of RF chains and a single antenna of the plurality of antennas for each link, a plurality of mapped links respectively associated with different frequency bands and different NAN map identifiers (Map IDs), to detect a trigger frame on any of the monitored mapped links; and
in response to detecting the trigger frame, during the active period, control the RF transceiver module to switch to the aggregated configuration in which at least two of the plurality of RF chains are aggregated to operate on a target link associated with the trigger frame using a multiple-input multiple-output (MIMO) configuration that employs at least two antennas of the plurality of antennas, to perform a data communication on the target link.

2. The wireless device of claim 1, wherein the processing circuit is further configured to establish, based on a handshake performed with a second NAN device, mapping entries that each associate a multi-link operation (MLO) link identifier (Link ID) with a NAN map identifier (Map ID), and to store the mapping entries in the memory, wherein the handshake comprises exchanging one or more messages with the second NAN device that convey mapping information for generating the mapping entries.

3. The wireless device of claim 2, wherein the one or more messages exchanged in the handshake comprise one or more NAN Data Path (NDP) setup frames.

4. The wireless device of claim 3, wherein the one or more NAN Data Path (NDP) setup frames further convey enhanced multi-link single radio (EMLSR) capability information that indicates whether the wireless device supports EMLSR operation.

5. The wireless device of claim 3, wherein the one or more NAN Data Path (NDP) setup frames include a Data Path Request frame and a Data Path Response frame.

6. The wireless device of claim 5, wherein the one or more NAN Data Path (NDP) setup frames further include a Data Path Confirm frame.

7. The wireless device of claim 1, wherein the RF transceiver module further includes a shared resource that is shared by the plurality of RF chains, and wherein, in the multiple-input multiple-output (MIMO) configuration, the shared resource causes the at least two antennas of the plurality of antennas to transmit wireless signals on the target link on a same frequency band.

8. The wireless device of claim 7, wherein the shared resource comprises at least one of a shared baseband circuit or a shared oscillator.

9. The wireless device of claim 1, wherein after completion of the data communication, the processing circuit controls the RF transceiver module to return to the monitoring configuration for a subsequent listen period.

10. The wireless device of claim 1, wherein the trigger frame comprises a trigger-type control frame selected from the group consisting of a Request-to-Send (RTS) frame, a Multi-User Request-to-Send (MU-RTS) frame, a Buffer Status Report Poll (BSRP) frame, and a trigger frame that schedules an uplink multi-user transmission.

11. A method for operating a wireless device as a Neighbor Awareness Networking (NAN) device, the wireless device comprising a radio-frequency (RF) transceiver module including a plurality of RF chains and a plurality of antennas coupled to the RF transceiver module, the method comprising:
time-division multiplexing operations of the RF transceiver module by alternating between a monitoring configuration during a listen period and an aggregated configuration during an active period;
during the listen period, monitoring, using a 1x1 configuration that employs a single RF chain of the plurality of RF chains and a single antenna of the plurality of antennas for each of a plurality of mapped links, the plurality of mapped links respectively associated with different frequency bands and different NAN map identifiers (Map IDs) to detect a trigger frame on any of the monitored mapped links; and
in response to detecting the trigger frame, during the active period, switching the RF transceiver module to the aggregated configuration in which at least two RF chains are aggregated to operate on a target link associated with the trigger frame using a multiple-input multiple-output (MIMO) configuration that employs at least two antennas of the plurality of antennas to perform a data communication on the target link.

12. The method of claim 11, further comprising establishing, based on a handshake performed with a second NAN device, mapping entries that each associate a multi-link operation (MLO) link identifier (Link ID) with a NAN map identifier (Map ID), and storing the mapping entries in a memory of the wireless device, wherein the handshake comprises exchanging one or more messages with the second NAN device that convey mapping information for generating the mapping entries.

13. The method of claim 12, wherein the one or more messages exchanged in the handshake comprise one or more NAN Data Path (NDP) setup frames.

14. The method of claim 13, wherein the one or more NAN Data Path (NDP) setup frames further convey enhanced multi-link single radio (EMLSR) capability information that indicates whether the wireless device supports EMLSR operation.

15. The method of claim 13, wherein the one or more NAN Data Path (NDP) setup frames include a Data Path Request frame and a Data Path Response frame.

16. The method of claim 15, wherein the one or more NAN Data Path (NDP) setup frames further include a Data Path Confirm frame.

17. The method of claim 11, wherein the wireless device further comprises a shared resource in the RF transceiver module that is shared by the plurality of RF chains, and wherein, in the multiple-input multiple-output (MIMO) configuration, the shared resource causes the at least two antennas of the plurality of antennas to transmit wireless signals on the target link on a same frequency band.

18. The method of claim 17, wherein the shared resource comprises at least one of a shared baseband circuit or a shared oscillator.

19. The method of claim 11, further comprising, after completion of the data communication, returning the RF transceiver module to the monitoring configuration for a subsequent listen period.

20. The method of claim 11, wherein the trigger frame comprises a trigger-type control frame selected from the group consisting of a Request-to-Send (RTS) frame, a Multi-User Request-to-Send (MU-RTS) frame, a Buffer Status Report Poll (BSRP) frame, and a trigger frame that schedules an uplink multi-user transmission.
